(19) United States
(12) Patent Application Publication
(10) Pub. No.: US 2015/0345480 A1
(43) Pub. Date: Dec. 3, 2015

(54) THERMALLY INTEGRATED CONCENTRATING SOLAR POWER SYSTEM WITH A FLUIDIZED SOLID PARTICLE RECEIVER

(71) Applicant: LAWRENCE LIVERMORE NATIONAL SECURITY, LLC, Livermore, CA (US)

(72) Inventor: Todd M. Bandhauer, Fort Collins, CO (US)

(21) Appl. No.: 14/670,023

(22) Filed: Mar. 26, 2015

Related U.S. Application Data
(60) Provisional application No. 62/004,092, filed on May 28, 2014.

(51) Int. Cl. F03G 6/00; F24J 2/28; F24J 2/34; F24J 2/00

(52) U.S. Cl. CPC F03G 6/00; F24J 2/0007; F24J 2/28; F24J 2/34

(57) ABSTRACT

Apparatus, systems, and method utilize a fluidized bed of solid particles to collect concentrated solar thermal energy in a compact receiver. Once energy is absorbed, these very hot particles are stored in a containment vessel. Heat is transferred to an air or other fluid stream and the stream is directed to a power generator or other unit.

### CROSS-REFERENCE TO RELATED APPLICATIONS

This application claims priority to and benefit under 35 U.S.C. §119(e) of U.S. Provisional Patent Application No. 62/004,092 filed May 28, 2014 entitled “Thermally Integrated Concentrating Solar Power System with a Fluidized Solid Particle Receiver,” the content of which is hereby incorporated by reference in its entirety for all purposes.

### STATEMENT AS TO RIGHTS TO APPLICATIONS MADE UNDER FEDERALLY SPONSORED RESEARCH AND DEVELOPMENT

The United States Government has rights in this application pursuant to Contract No. DE-AC52-07NA27344 between the United States Department of Energy and Lawrence Livermore National Security, LLC for the operation of Lawrence Livermore National Laboratory.

### BACKGROUND

1. Field of Endeavor

The present application relates to solar energy and more particularly to a thermally integrated concentrating solar power system with a fluidized solid particle receiver.

2. State of Technology

This section provides background information related to the present disclosure which is not necessarily prior art.

U.S. Pat. No. 7,735,323 for a solar thermal power system, issued to Charles L. Bennett Jun. 15, 2010, includes the state of technology information reproduced below.
Solar thermal power plants and systems using DSG processes are known for use in various applications, including for example powering a steam turbine and generating electricity. DSG systems typically use solar concentrators or collectors, such as parabolic trough collectors or dish collectors known in the art, to focus solar radiation onto a vessel or tube in which, for example, water is flowed or otherwise present, to heat the water into steam. In such systems, work is then typically produced by expanding the steam in an expander, such as a turbine, after which the working fluid may be condensed in a condenser for recirculation in the case of closed systems, or expelled in the case of open systems.
The difficulty of controlling DSG systems stems from the combined effects of predictable variations in solar illumination through the diurnal cycle, the unpredictable variations produced by transients from passing clouds or other obscurations, and the effects of the fundamental two-phase fluid flow Ledinegg instability. As is known in the art, as heat is applied to a conventional boiler tube, there is a tendency for the boiling water to “chug and spit” in an irregular and unstable fashion as it boils. This fluid flow instability causes the familiar gurgling and sputtering noises often heard in coffee percolators. The combination of fluid flow instability and solar transients tends to have as a consequence the formation of potentially damaging. “hot spots” along the boiler tube. The origin of this so-called Ledinegg instability is due to the tendency for a sudden, rapid increase in the liquid flow rate as bubbles of gas phase steam are produced and tend to propel uncontrolled “slugs” of liquid water at high speed along the flow direction.
Another issue known in the art is the lack of suitable thermal energy storage technology for DSG processes and systems In a presentation at the Parabolic Trough Workshop in Denver in 2007, “Overview on Direct Steam Generation (DSG) and Experience at the Plataforma Solar de Almeria (PSA)”, Zarza states that a suitable thermal energy storage technology for DSG is still to be developed. One of the most significant motivations for the use of thermal energy storage in connection with a solar thermal power plant is that, whereas the maximum solar flux typically occurs at near noon, the maximum electric power consumption typically occurs about four hours later. The greatest burden on the electric power grid occurs during these times of greatest electricity consumption. This burden is especially great for the sunniest, hottest days of the summer months. The economic manifestation of this phenomenon is that the market value of electric power is greater during periods of peak need. For example, in the Mar. 8, 2007 publication entitled, “A Utility's Perspective, Procuring Renewable Energy” published by the Pacific Gas and Electric Company, the multiplier on the market value for electric power between the work day hours of noon and 8 p.m., for the months June through September, is described as being a factor of two. Thus, besides addressing the electric power needs in a more timely manner (when observing the demands on the power grid as a whole), there is in addition, great economic incentive (to the individual consumer) for the incorporation of inexpensive thermal energy storage for solar thermal power plants. In other words, for the individual consumer it is cheaper to produce/consume your own electricity during these peak times, than to buy it.
In summary, there is therefore a need for a DSG type solar thermal power generation system which provides a solution to the problems of solar field control under solar radiation transients and the related problem of the instability of two-phase flow inside the receiver tubes, as well as provides suitable thermal energy storage technology for DSG systems that enables time shifting of the available thermal energy to better align supply with demand.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

To compete with traditional generation technologies, electricity produced from intermittent solar energy requires inexpensive energy storage technologies. In addition, high temperatures (>1000 K) possible from concentrating solar energy can lead to high thermodynamic efficiency, but efficient heat transfer from thermal storage media to the working fluid is required. The disclosed apparatus, systems, and methods solve these problems by utilizing a fluidized bed of solid particles to collect concentrated solar thermal energy in a compact receiver, and, once sufficient energy is absorbed, storing these very hot particles in a containment vessel that transfers heat to an air or other fluid stream and the stream is directed to a power generator or other unit. As used in this application the term “particles” means: sand, pebbles, balls, spheres, nanoparticles, or other small bodies. The fluidized bed and storage silo both operate at low pressure, minimizing cost of high temperature containment. The system also utilizes counterflow heat exchange between fluids that are able to withstand very high temperatures (air and solid particles). As a result, high thermodynamic efficiencies are achieved in a high temperature air Brayton cycle that also utilizes effective counterflow heat exchange.

The disclosed apparatus, systems, and methods have many uses. For example, the disclosed apparatus, systems, and methods can be used to produce electricity at night and on overcast days as well as during fully sunny days. This allows the use of solar power for baseload generation as well as peakpower, with the potential of displacing both coal- and natural gas-fired power plants. The disclosed apparatus, systems, and methods have use in concentrating solar power by a fluidized solid particle receiver and high temperature thermal storage for solar energy.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

### BRIEF DESCRIPTION OF THE DRAWINGS

The accompanying drawings, which are incorporated into and constitute a part of the specification, illustrate specific embodiments of the apparatus, systems, and methods and, together with the general description given above, and the detailed description of the specific embodiments, serve to explain the principles of the apparatus, systems, and methods.

FIG. 1 illustrates a first example embodiment of the solar thermal power system using the disclosed apparatus, systems, and methods.

FIG. 2 illustrates another embodiment example of a solar thermal power system that includes capture of excess heat from the Counter Flow Heat Exchanger.

FIG. 3 illustrates yet another embodiment example of a solar thermal power system that includes capture of excess heat from the turbine.

FIG. 4 illustrates an additional embodiment example of a solar thermal power system that includes capture of excess heat from the Counter Flow Heat Exchanger and from the turbine.

FIG. 5 is a simplified view of the solar concentrator used in Applicant's disclosed apparatus, systems, and methods.

FIG. 6 is a simplified view of the counter flow heat exchangers used in Applicant's disclosed apparatus, systems, and methods.

### DETAILED DESCRIPTION OF SPECIFIC EMBODIMENTS

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

The disclosed apparatus, systems, and methods include a solar collector that collects solar energy; a solar receiver operatively connected to the solar collector; a fluidized particle bed in the solar receiver, the fluidized bed containing particles wherein the solar energy from the solar collector is transferred to the particles; a storage container; a system for conveying the particles with the solar energy from the fluidized particle bed to the storage container wherein the storage container is a repository for the particles with the solar energy; a power generation system; and a system for transferring the solar energy from the particles in the storage container to the power generation system. The solar collector and fluidized bed of particles are used to collect solar thermal energy from a solar collector in a compact solar receiver. Once sufficient energy is absorbed, these very hot particles are conveyed to a storage container. Air is used as the primary heat transfer fluid for the power cycle.

The disclosed apparatus, systems, and methods allow a solar thermal plant to produce electricity at night and on overcast days as well as during fully sunny days. This allows the use of solar power for baseload generation as well as peakpower, with the potential of displacing both coal- and natural gas-fired power plants.

During the day concentrated solar energy is collected at the compact high temperature receiver with fluidized solid particle bed and the collected heat is used to drive a turbine and compressor to provide an output that can be used to drive an electrical generator. Simultaneously, the collected heat is transferred to the insulated storage silo where it is captured and stored for future use.

During the night there is no solar energy; therefore, the stored heat in the insulated storage silo is used to drive the turbine and compressor which provides an output used to drive an electrical generator.

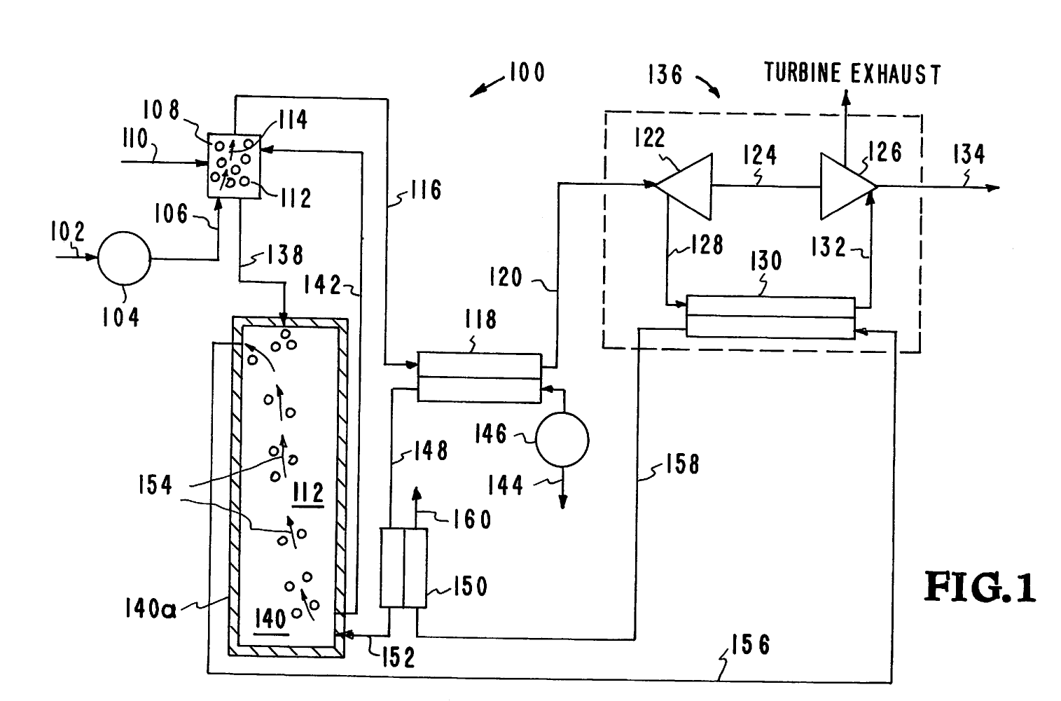

Referring now to the drawings, and in particular to FIG. 1, a first example embodiment of a solar thermal power system using the disclosed apparatus, systems, and methods is illustrated. This first example embodiment is generally designated by the reference character 100. In particular, FIG. 1 shows a schematic view of an arrangement/configuration of the main components of the first embodiment system 100. The reference numbers and a brief description of the main components of the first embodiment system 100 are listed below.
100—Thermally integrated Concentrated Solar Power (CSP) System
102—Working Fluid (Ambient Air) Source
104—Pump (Blower) Low Pressure
106—Line
108—Compact High Temperature Receiver with Fluidized Solid Particle Bed
110—Concentrated Solar Power
112—Fluidized Particle Bed
114—Flow Arrows (Working Fluid Thru Particle Bed)
116—Line (Heated Working Fluid from Particle Bed)
118—Counter Flow Heat Exchanger #1
120—Line from 118 to Compressor 122
122—Compressor
124—Shaft
126—Turbine
128—Line from Compressor to Counter Flow Heat Exchanger #2 (130)
130—Counter Flow Heat Exchanger
132—Line from H.E. to Turbine 126
134—Shaft (work out to Electrical Generator etc.)
136—Brayton Cycle System I items 122, 124, 126, 128, 130, 132)
138—Line heated solid particles from fluid bed to storage silo
140—insulated Storage Silo
140a—Insulator
142—Line to recycle solid particle 112 from storage silo 140 to receiver 108
144—Working Fluid (air) Source
146—Low Temperature Blower
148—Line from H.E. #1 (118) to H.E. #3 (150)
150—H.E. #3
152—Line from H.E. #3 (150) to storage silo 140
154—Flow arrows indicating working fluid flow thru stored hot particles (112)
156—Line with very high temperature working fluid from storage silo (140) to H.E. #2 (130)
158—Line from H.E. #2 (130) with working fluid that has been cooled by passing thru H.E. #2 (130)
160—Exhaust

The disclosed apparatus, systems, and methods utilize a fluidized bed of inexpensive solid particles to collect concentrated solar thermal energy in a compact receiver, and, once sufficient energy is absorbed, storing these very hot particles in a containment vessel that transfers heat directs to air. Solid particle receivers have been utilized for thermal storage, but typically in a falling curtain. This requires prohibitively large receivers due to the solid particles rapidly falling. This large size causes undesirable heat loss, thus reducing net thermal efficiency. One method for reducing heat loss is to use material that has been engineered to have high thermal absorption (e.g., sintered bauxite), but this adds unnecessary cost to the system. In addition, it remains difficult to extract heat from the storage medium once it is stored, especially because few heat transfer fluids exists that can withstand high temperatures.

In the disclose system, a fluidized bed of solid particles is utilized to minimize heat loss to the surrounding ambient while simultaneously enabling extremely high storage medium temperatures. Once stored, air is used as the primary heat transfer fluid for the power cycle, eliminating the inability to operate at high temperatures.

The components of Applicant's disclosed apparatus, systems, and methods 100 having been described, the operation of Applicant's disclosed apparatus, systems, and methods will now be considered. The disclosed apparatus, systems, and methods 100 allow a solar thermal plant to produce electricity at night and on overcast days as well as during fully sunny days. This allows the use of solar power for baseload generation as well as peakpower, with the potential of displacing both coal- and natural gas-fired power plants.

During the day concentrated solar energy 110 is collected at the compact high temperature receiver with fluidized solid particle bed 108 and the collected heat is used to drive turbine 126 and compressor 122 to provide an output through shaft 134 that can be used to drive an electrical generator.

Simultaneously, the collected heat is transferred to the insulated storage silo 140 where it is captured and stored for future use.

During the night there is no solar energy; therefore, the stored heat in the insulated storage silo 140 is used to drive turbine 126 and compressor 122 which provides an output through shaft 134 that can be used to drive an electrical generator.

Referring again to FIG. 1, the operation of Applicant's disclosed apparatus, systems, and methods 100 begins with concentrated solar energy 110 being collected at the compact high temperature receiver with fluidized solid particle bed 108. The compact high temperature receiver with fluidized solid particle bed 108 includes fluidized particle bed 112.

During the day heat energy is collected at the compact high temperature receiver with fluidized solid particle bed 108. During the day the heat energy is used for two operations: (1) directly providing power output 134 using the Brayton cycle system 136 and (2) building up stored energy in the insulated storage silo 140 for use at night and on overcast days. The Brayton cycle system is a thermodynamic cycle that describes the workings of a constant pressure heat engine. Turbine engines and jet engines can use the Brayton Cycle. Although the Brayton cycle is usually run as an open system, it is conventionally assumed for the purposes of thermodynamic analysis that the exhaust gases are reused in the intake, enabling analysis as a closed system. The Brayton cycle sy is named after George Brayton (1830-1892), the American engineer who developed it, although it was originally proposed and patented by Englishman John Barber in 1791. It is also sometimes known as the Joule cycle. Brayton cycle systems are well known in the art and all the details of the system will not be included here. It is to be understood that the Brayton cycle system 136 can be any of the Brayton cycle systems know in the art.

With regard to operation (1), working fluid 102 is directed into the compact high temperature receiver with fluidized solid particle bed 108 using the pump 104. The arrows 114 illustrate the flow of working fluid thru the fluidized solid particle bed 108. The working fluid takes up the heat energy in the fluidized solid particle bed 108. The heat energy is transferred to the counter flow heat exchanger 118 through the line (heated working fluid from particle bed) 116 and the to the Brayton cycle system 136 through line 120. The Brayton cycle system 136 uses the heat energy to drive turbine 126 and compressor 122 and provide an output through shaft 124 and 134 that can be used to drive an electrical generator.

One of the most significant motivations for the use of thermal energy storage in connection with a solar thermal power plant is that, whereas the maximum solar flux typically occurs at near noon, the maximum electric power consumption typically occurs about four hours later. The greatest burden on the electric power grid occurs during these times of greatest electricity consumption. This burden is especially great for the sunniest, hottest days of the summer months. Applicant's apparatus, systems and methods are able to help with this burden by directly producing power with the Brayton cycle system 136 during the times of maximum solar flux and to supplement the production of power using stored energy in the insulated storage silo 140 by that is transferred to the Brayton cycle system 136 through the counter flow heat exchanger 130 during these times of greatest electricity consumption.

With regard to operation (2), working fluid 102 is directed into the compact high temperature receiver with fluidized solid particle bed 108 using the pump 104. The particles in one embodiment are sand particles. In another embodiment the particles are pebbles. In another embodiment the particles are spheres. In another embodiment the particles are sintered bauxite. In another embodiment the particles are nanoparticles.

The arrows 114 illustrate the flow of working fluid thru the fluidized solid particle bed 108. The particles are transferred into the insulated storage silo 140 through line 138. The insulated storage silo 140 includes a heat insulator 140a. The heat insulator 140a is a substance, whether solid, liquid, or gas, that retards heat flow from the warmer particles in the storage silo 140 to the less warm environment around the storage silo 140. In one embodiment the heat insulator 140a is a fiberglass heat insulator material. In another embodiment the heat insulator 140a is a mineral wool heat insulator material. In another embodiment the heat insulator 140a is a cellulose heat insulator material. In another embodiment the heat insulator 140a is a polyurethane foam heat insulator material. The heat energy collected at the compact high temperature receiver with fluidized solid particle bed 108 is stored in the insulated storage silo 140.

At night and on overcast days, the heat that is stored in the insulated storage silo 140 is used to provide power through shaft 134 that can be used to drive an electrical generator. The heat that is stored in the insulated storage silo 140 is directed to the Brayton cycle system 136 that provides power at night and on overcast days.

In directing the heat to the Brayton cycle system 136, a working fluid such as air is directed to the insulated storage silo 140 through line 152. The working fluid is moved through the heat exchanges 118 and 150 by the blower 146 and then through line 152 to the insulated storage silo 140. The arrows 154 in the fluidized particle bed 112 in the insulated storage silo 140 illustrate the transfer and collection of heat by the working fluid as it moves through the fluidized particle bed 112 in the insulated storage silo 140. The working fluid with the accumulated heat energy is transferred to the Brayton cycle system 136 through line 156 and the counter flow heat exchanger 130.

The Brayton Cycle 136 utilizes the heat energy to turbine 126 which in turn drives compressor 122 to provide an output through shaft 134 that can be used to drive an electrical generator. The heat energy is directed to the turbine 126 through line 132. The energy is then transferred through the shaft 124 to the compressor 122 which drives shaft 124 and the output shaft 134.

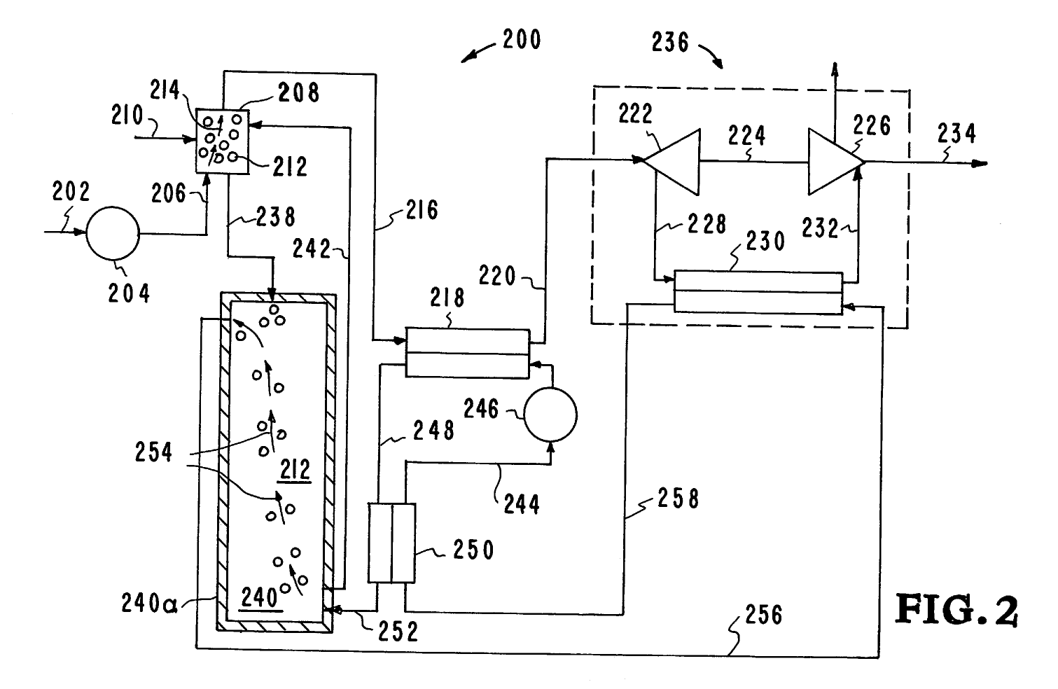

Referring now to FIG. 2, another embodiment example of a solar thermal power system using the disclosed apparatus, systems, and methods is illustrated. This additional example embodiment is generally designated by the reference character 200. The additional example embodiment system 200 very similar to the system 100 illustrated in FIG. 1; however the system 200 includes capture of excess heat from the Counter Flow Heat Exchanger #2 identified by the reference numeral 230.

FIG. 2 shows a schematic view of an arrangement/configuration of the components of the additional example embodiment system 200. The reference numbers and a brief description of the components of the system 200 are listed below.
200—Thermally integrated Concentrated Solar Power (CSP) System
202—Working Fluid (Ambient Air) Source
204—Pump (Blower) Low Pressure
206—Line
208—Compact High Temperature Receiver with Fluidized Solid Particle Bed
210—Concentrated Solar Power
212—Fluidized Particle Bed
214—Flow Arrows (Working Fluid Thru Particle Bed)
216—Line (Heated Working Fluid from Particle Bed)
218—Counter Flow Heat Exchanger #1
220—Line from 218 to Compressor 222
222—Compressor
224—Shaft
226—Turbine
228—Line from Compressor to Counter Flow Heat Exchanger #2 (230)
230—Counter Flow Heat Exchanger
232—Line from H.E. to Turbine 226
234—Shaft (work out to Electrical Generator etc.)
236—Brayton Cycle System I items 222, 224, 226, 228, 230, 232)
238—Line heated solid particles from fluid bed to storage silo
240—Insulated Storage Silo
240a—Insulator
242—Line to recycle solid particle 212 from storage silo 240 to receiver 208
244—Working Fluid (air) Source
246—Low Temperature Blower
248—Line from H.E. #1 (218) to H.E. #3 (′250)
250—H.E. #3
252—Line from H.E. #3 (250) to storage silo 240
254—Flow arrows indicating working fluid flow thru stored hot particles (212)
256—Line with very high temperature working fluid from storage silo (240) to H.E. #2 (230)
258—Line from H.E. #2 with working fluid that has passed thru H.E. #2 (230) has collected excess heat.

The disclosed apparatus, systems, and methods utilize a fluidized bed of inexpensive solid particles to collect concentrated solar thermal energy in a compact receiver, and, once sufficient energy is absorbed, storing these very hot particles in a containment vessel that transfers heat directs to air. Solid particle receivers have been utilized for thermal storage, but typically in a falling curtain. This requires prohibitively large receivers due to the solid particles rapidly falling. This large size causes undesirable heat loss, thus reducing net thermal efficiency. One method for reducing heat loss is to use material that has been engineered to have high thermal absorption (e.g., sintered bauxite), but this adds unnecessary cost to the system. In addition, it remains difficult to extract heat from the storage medium once it is stored, especially because few heat transfer fluids exists that can withstand high temperatures.

In the disclose system, a fluidized bed of solid particles is utilized to minimize heat loss to the surrounding ambient while simultaneously enabling extremely high storage medium temperatures. Once stored, air is used as the primary heat transfer fluid for the power cycle, eliminating the inability to operate at high temperatures.

The components of Applicant's disclosed apparatus, systems, and methods 200 having been described, the operation of Applicant's disclosed apparatus, systems, and methods will now be considered. The disclosed apparatus, systems, and methods 200 allow a solar thermal plant to produce electricity at night and on overcast days as well as during fully sunny days. This allows the use of solar power for baseload generation as well as peakpower, with the potential of displacing both coal- and natural gas-fired power plants.

During the day concentrated solar energy 210 is collected at the compact high temperature receiver with fluidized solid particle bed 208 and the collected heat is used to drive turbine 226 and compressor 222 to provide an output through shaft 234 that can be used to drive an electrical generator.

Simultaneously, the collected heat is transferred to the insulated storage silo 240 where it is captured and stored for future use.

During the night there is no solar energy; therefore, the stored heat in the insulated storage silo 240 is used to drive turbine 226 and compressor 222 which provides an output through shaft 234 that can be used to drive an electrical generator.

Referring again to FIG. 2, the operation of Applicant's disclosed apparatus, systems, and methods 200 begins with concentrated solar energy 210 being collected at the compact high temperature receiver with fluidized solid particle bed 208. The compact high temperature receiver with fluidized solid particle bed 208 includes fluidized particle bed 212.

During the day heat energy is collected at the compact high temperature receiver with fluidized solid particle bed 208. During the day the heat energy is used for two operations: (1) directly providing power output 234 using the Brayton cycle system 236 and (2) building up stored energy in the insulated storage silo 240 for use at night and on overcast days. The Brayton cycle system is a thermodynamic cycle that describes the workings of a constant pressure heat engine. Turbine engines and jet engines can use the Brayton Cycle. Although the Brayton cycle is usually run as an open system, it is conventionally assumed for the purposes of thermodynamic analysis that the exhaust gases are reused in the intake, enabling analysis as a closed system. The Brayton cycle sy is named after George Brayton (1830-1892), the American engineer who developed it, although it was originally proposed and patented by Englishman John Barber in 1791. It is also sometimes known as the Joule cycle. Brayton cycle systems are well known in the art and all the details of the system will not be included here. It is to be understood that the Brayton cycle system 236 can be any of the Brayton cycle systems know in the art.

With regard to operation (1), working fluid 202 is directed into the compact high temperature receiver with fluidized solid particle bed 208 using the pump 204. The arrows 214 illustrate the flow of working fluid thru the fluidized solid particle bed 208. The working fluid takes up the heat energy in the fluidized solid particle bed 208. The heat energy is transferred to the counter flow heat exchanger 218 through the line (heated working fluid from particle bed) 216 and the to the Brayton cycle system 236 through line 220. The Brayton cycle system 236 uses the heat energy to drive turbine 226 and compressor 222 and provide an output through shaft 224 and 234 that can be used to drive an electrical generator.

One of the most significant motivations for the use of thermal energy storage in connection with a solar thermal power plant is that, whereas the maximum solar flux typically occurs at near noon, the maximum electric power consumption typically occurs about four hours later. The greatest burden on the electric power grid occurs during these times of greatest electricity consumption. This burden is especially great for the sunniest, hottest days of the summer months. Applicant's apparatus, systems and methods are able to help with this burden by directly producing power with the Brayton cycle system 236 during the times of maximum solar flux and to supplement the production of power using stored energy in the insulated storage silo 240 by that is transferred to the Brayton cycle system 236 through the counter flow heat exchanger 230 during these times of greatest electricity consumption.

With regard to operation (2), working fluid 202 is directed into the compact high temperature receiver with fluidized solid particle bed 208 using the pump 204. The particles in one embodiment are sand particles. In another embodiment the particles are pebbles. In another embodiment the particles are nanoparticles. In another embodiment the particles are spheres. The arrows 214 illustrate the flow of working fluid thru the fluidized solid particle bed 208. The particles are transferred into the insulated storage silo 240 through line 238. The insulated storage silo 240 includes a heat insulator 240a. The heat insulator 240a is a substance, whether solid, liquid, or gas, that retards heat flow from the warmer particles in the storage silo 240 to the less warm environment around the storage silo 240. In one embodiment the heat insulator 240a is a fiberglass heat insulator material. In another embodiment the heat insulator 240a is a mineral wool heat insulator material. In another embodiment the heat insulator 240a is a cellulose heat insulator material. In another embodiment the heat insulator 240a is a polyurethane foam heat insulator material. The heat energy collected at the compact high temperature receiver with fluidized solid particle bed 208 is stored in the insulated storage silo 240.

At night and on overcast days, the heat that is stored in the insulated storage silo 240 is used to provide power through shaft 234 that can be used to drive an electrical generator. The heat that is stored in the insulated storage silo 240 is directed to the Brayton cycle system 236 that provides power at night and on overcast days.

In directing the heat to the Brayton cycle system 236, a working fluid such as air is directed to the insulated storage silo 240 through line 252. The working fluid is moved through the heat exchanges 218 and 250 by the blower 246 and then through line 252 to the insulated storage silo 240. The arrows 254 in the fluidized particle bed 212 in the insulated storage silo 240 illustrate the transfer and collection of heat by the working fluid as it moves through the fluidized particle bed 212 in the insulated storage silo 240. The working fluid with the accumulated heat energy is transferred to the Brayton cycle system 236 through line 256 and the counter flow heat exchanger 230. The system 200 includes capture of excess heat from the Counter Flow Heat Exchanger #2 identified by the reference numeral 230. The line 258 with the excess heat directs the excess heat through units 250 and 246 to the heat exchanger 218.

The Brayton Cycle 236 utilizes the heat energy to turbine 226 which in turn drives compressor 222 to provide an output through shaft 234 that can be used to drive an electrical generator. The heat energy is directed to the turbine 226 through line 232. The energy is then transferred through the shaft 224 to the compressor 222 which drives shaft 224 and the output shaft 234.

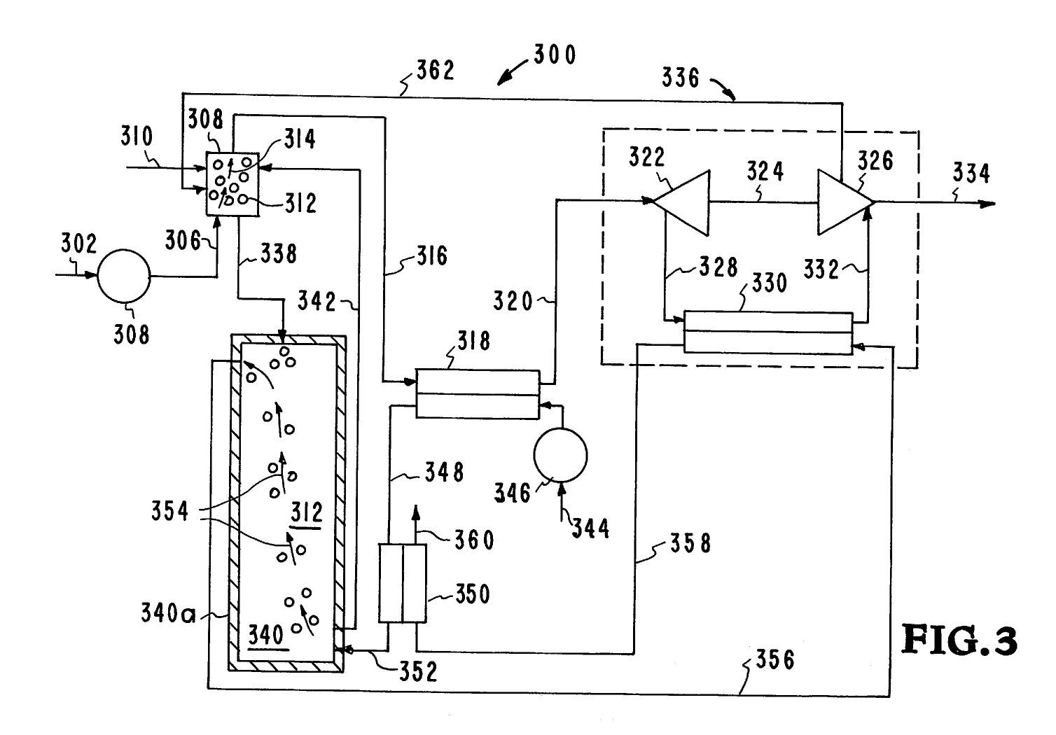

Referring now to FIG. 3, another embodiment example of a solar thermal power system using the disclosed apparatus, systems, and methods is illustrated. This additional example embodiment is generally designated by the reference character 300. The additional example embodiment system 300 very similar to the system 100 illustrated in FIG. 1; however the system 300 includes capture of excess heat from the turbine identified by the reference numeral 326.
300—Thermally integrated Concentrated Solar Power (CSP) System
302—Working Fluid (Ambient Air) Source
304—Pump (Blower) Low Pressure
306—Line
308—Compact High Temperature Receiver with Fluidized Solid Particle Bed
310—Concentrated Solar Power
312—Fluidized Particle Bed
314—Flow Arrows (Working Fluid Thru Particle Bed)
316—Line (Heated Working Fluid from Particle Bed)
318—Counter Flow Heat Exchanger #1
320—Line from 318 to Compressor 322
322—Compressor
324—Shaft
326—Turbine
328—Line from Compressor to Counter Flow Heat Exchanger #2 (330)
330—Counter Flow Heat Exchanger
332—Line from H.E. to Turbine 326
334—Shaft (work out to Electrical Generator etc.)
336—Brayton Cycle System I items 322, 324, 326, 328, 330, 332)
338—Line heated solid particles from fluid bed to storage silo
340—Insulated Storage Silo
340a—Insulator
342—Line to recycle solid particle 312 from storage silo 340 to receiver 308
344—Working Fluid (air) Source
346—Low Temperature Blower
348—Line from H.E. #1 (318) to H.E. #3 (350)
350—H.E. #3
352—Line from H.E. #3 (350) to storage silo 340
354—Flow arrows indicating working fluid flow thru stored hot particles (312)
356—Line with very high temperature working fluid from storage silo (340) to H.E. #2 (330)
358—Line from H.E. #2 (330) with working fluid that has been cooled by passing thru H.E. #2 (330)
360—Exhaust
362—Line from Turbine 326 to Fluidized Particle Bed 112.

The disclosed apparatus, systems, and methods utilize a fluidized bed of inexpensive solid particles to collect concentrated solar thermal energy in a compact receiver, and, once sufficient energy is absorbed, storing these very hot particles in a containment vessel that transfers heat directs to air. Solid particle receivers have been utilized for thermal storage, but typically in a falling curtain. This requires prohibitively large receivers due to the solid particles rapidly falling. This large size causes undesirable heat loss, thus reducing net thermal efficiency. One method for reducing heat loss is to use material that has been engineered to have high thermal absorption (e.g., sintered bauxite), but this adds unnecessary cost to the system. In addition, it remains difficult to extract heat from the storage medium once it is stored, especially because few heat transfer fluids exists that can withstand high temperatures.

In the disclose system, a fluidized bed of solid particles is utilized to minimize heat loss to the surrounding ambient while simultaneously enabling extremely high storage medium temperatures. Once stored, air is used as the primary heat transfer fluid for the power cycle, eliminating the inability to operate at high temperatures.

The components of Applicant's disclosed apparatus, systems, and methods 300 having been described, the operation of Applicant's disclosed apparatus, systems, and methods will now be considered. The disclosed apparatus, systems, and methods 300 allow a solar thermal plant to produce electricity at night and on overcast days as well as during fully sunny days. This allows the use of solar power for baseload generation as well as peakpower, with the potential of displacing both coal- and natural gas-fired power plants.

During the day concentrated solar energy 310 is collected at the compact high temperature receiver with fluidized solid particle bed 308 and the collected heat is used to drive turbine 326 and compressor 322 to provide an output through shaft 334 that can be used to drive an electrical generator.

Simultaneously, the collected heat is transferred to the insulated storage silo 340 where it is captured and stored for future use.

During the night there is no solar energy; therefore, the stored heat in the insulated storage silo 340 is used to drive turbine 326 and compressor 322 which provides an output through shaft 334 that can be used to drive an electrical generator.

Referring again to FIG. 3, the operation of Applicant's disclosed apparatus, systems, and methods 300 begins with concentrated solar energy 310 being collected at the compact high temperature receiver with fluidized solid particle bed 308. The compact high temperature receiver with fluidized solid particle bed 308 includes fluidized particle bed 312.

During the day heat energy is collected at the compact high temperature receiver with fluidized solid particle bed 308. During the day the heat energy is used for two operations: (1) directly providing power output 334 using the Brayton cycle system 336 and (2) building up stored energy in the insulated storage silo 340 for use at night and on overcast days. The Brayton cycle system is a thermodynamic cycle that describes the workings of a constant pressure heat engine. Turbine engines and jet engines can use the Brayton Cycle. Although the Brayton cycle is usually run as an open system, it is conventionally assumed for the purposes of thermodynamic analysis that the exhaust gases are reused in the intake, enabling analysis as a closed system. The Brayton cycle sy is named after George Brayton (1830-1892), the American engineer who developed it, although it was originally proposed and patented by Englishman John Barber in 1791. It is also sometimes known as the Joule cycle. Brayton cycle systems are well known in the art and all the details of the system will not be included here. It is to be understood that the Brayton cycle system 336 can be any of the Brayton cycle systems know in the art.

With regard to operation (1), working fluid 302 is directed into the compact high temperature receiver with fluidized solid particle bed 308 using the pump 304. The arrows 314 illustrate the flow of working fluid thru the fluidized solid particle bed 308. The working fluid takes up the heat energy in the fluidized solid particle bed 308. The heat energy is transferred to the counter flow heat exchanger 318 through the line (heated working fluid from particle bed) 316 and the to the Brayton cycle system 336 through line 320. The Brayton cycle system 336 uses the heat energy to drive turbine 326 and compressor 322 and provide an output through shaft 324 and 334 that can be used to drive an electrical generator.

One of the most significant motivations for the use of thermal energy storage in connection with a solar thermal power plant is that, whereas the maximum solar flux typically occurs at near noon, the maximum electric power consumption typically occurs about four hours later. The greatest burden on the electric power grid occurs during these times of greatest electricity consumption. This burden is especially great for the sunniest, hottest days of the summer months. Applicant's apparatus, systems and methods are able to help with this burden by directly producing power with the Brayton cycle system 336 during the times of maximum solar flux and to supplement the production of power using stored energy in the insulated storage silo 340 by that is transferred to the Brayton cycle system 336 through the counter flow heat exchanger 330 during these times of greatest electricity consumption.

With regard to operation (2), working fluid 302 is directed into the compact high temperature receiver with fluidized solid particle bed 308 using the pump 304. The particles in one embodiment are sand particles. In another embodiment the particles are pebbles. In another embodiment the particles are nanoparticles. In another embodiment the particles are spheres. The arrows 314 illustrate the flow of working fluid thru the fluidized solid particle bed 308. The particles are transferred into the insulated storage silo 340 through line 338. The insulated storage silo 340 includes a heat insulator 340a. The heat insulator 340a is a substance, whether solid, liquid, or gas, that retards heat flow from the warmer particles in the storage silo 340 to the less warm environment around the storage silo 340. In one embodiment the heat insulator 340a is a fiberglass heat insulator material. In another embodiment the heat insulator 340a is a mineral wool heat insulator material. In another embodiment the heat insulator 340a is a cellulose heat insulator material. In another embodiment the heat insulator 340a is a polyurethane foam heat insulator material. The heat energy collected at the compact high temperature receiver with fluidized solid particle bed 308 is stored in the insulated storage silo 340.

At night and on overcast days, the heat that is stored in the insulated storage silo 340 is used to provide power through shaft 334 that can be used to drive an electrical generator. The heat that is stored in the insulated storage silo 340 is directed to the Brayton cycle system 336 that provides power at night and on overcast days.

In directing the heat to the Brayton cycle system 336, a working fluid such as air is directed to the insulated storage silo 340 through line 352. The working fluid is moved through the heat exchanges 318 and 350 by the blower 346 and then through line 352 to the insulated storage silo 340. The arrows 354 in the fluidized particle bed 312 in the insulated storage silo 340 illustrate the transfer and collection of heat by the working fluid as it moves through the fluidized particle bed 312 in the insulated storage silo 340. The working fluid with the accumulated heat energy is transferred to the Brayton cycle system 336 through line 356 and the counter flow heat exchanger 330.

The system 300 includes capture of excess heat from the turbine 326. The excess heat from the turbine 326 is transferred to the Fluidized Bed 112 through line 362.

The Brayton Cycle 336 utilizes the heat energy to turbine 326 which in turn drives compressor 322 to provide an output through shaft 334 that can be used to drive an electrical generator. The heat energy is directed to the turbine 326 through line 332. The energy is then transferred through the shaft 324 to the compressor 322 which drives shaft 324 and the output shaft 334.

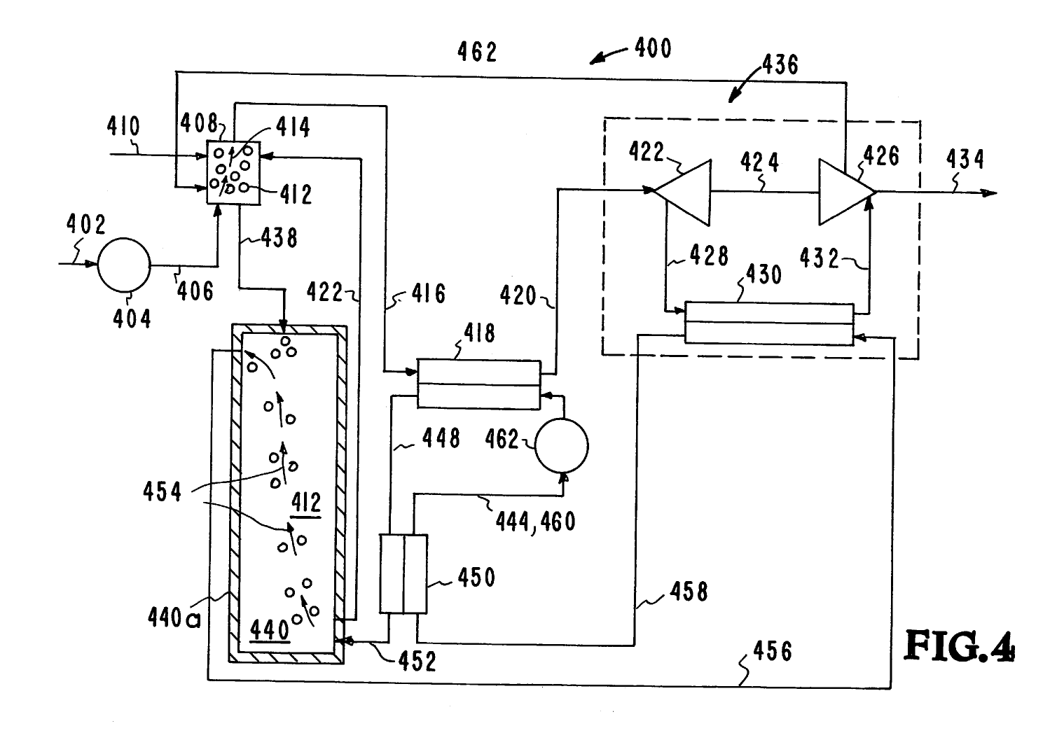

Referring now to FIG. 4, another embodiment example of a solar thermal power system using the disclosed apparatus, systems, and methods is illustrated. This additional example embodiment is generally designated by the reference character 400. The additional example embodiment system 400 very similar to the system 100 illustrated in FIG. 1; however the system 400 includes capture of excess heat from the Counter Flow Heat Exchanger #2 identified by the reference numeral 430.

FIG. 4 shows a schematic view of an arrangement/configuration of the components of the additional example embodiment system 400. The reference numbers and a brief description of the components of the system 400 are listed below.
400—Thermally integrated Concentrated Solar Power (CSP) System
402—Working Fluid (Ambient Air) Source
404—Pump (Blower) Low Pressure
406—Line
408—Compact High Temperature Receiver with Fluidized Solid Particle Bed
410—Concentrated Solar Power
412—Fluidized Particle Bed
414—Flow Arrows (Working Fluid Thru Particle Bed)
416—Line (Heated Working Fluid from Particle Bed)
418—Counter Flow Heat Exchanger #1
420—Line from 418 to Compressor 422
422—Compressor
424—Shaft
426—Turbine
428—Line from Compressor to Counter Flow Heat Exchanger #2 (430)
430—Counter Flow Heat Exchanger
432—Line from H.E. to Turbine 426
434—Shaft (work out to Electrical Generator etc.)
436—Brayton Cycle System I items 422, 424, 426, 428, 430, 432)
438—Line heated solid particles from fluid bed to storage silo
440—Insulated Storage Silo
440a—Insulator
442—Line to recycle solid particle 412 from storage silo 440 to receiver 408
444—Working Fluid (air) Source
446—Low Temperature Blower
448—Line from H.E. #1 (418) to H.E. #3 (′450)
450—H.E. #3
452—Line from H.E. #3 (450) to storage silo 440
454—Flow arrows indicating working fluid flow thru stored hot particles (412)
456—Line with very high temperature working fluid from storage silo (440) to H.E. #2 (430)
458—Line from H.E. #2 with working fluid that has passed thru H.E. #2 (430) has collected excess heat
460—captured excess heat
462—Line from Turbine 426 to Fluidized Particle Bed 412.

The disclosed apparatus, systems, and methods utilize a fluidized bed of inexpensive solid particles to collect concentrated solar thermal energy in a compact receiver, and, once sufficient energy is absorbed, storing these very hot particles in a containment vessel that transfers heat directs to air. Solid particle receivers have been utilized for thermal storage, but typically in a falling curtain. This requires prohibitively large receivers due to the solid particles rapidly falling. This large size causes undesirable heat loss, thus reducing net thermal efficiency. One method for reducing heat loss is to use material that has been engineered to have high thermal absorption (e.g., sintered bauxite), but this adds unnecessary cost to the system. In addition, it remains difficult to extract heat from the storage medium once it is stored, especially because few heat transfer fluids exists that can withstand high temperatures.

In the disclose system, a fluidized bed of solid particles is utilized to minimize heat loss to the surrounding ambient while simultaneously enabling extremely high storage medium temperatures. Once stored, air is used as the primary heat transfer fluid for the power cycle, eliminating the inability to operate at high temperatures.

The components of Applicant's disclosed apparatus, systems, and methods 400 having been described, the operation of Applicant's disclosed apparatus, systems, and methods will now be considered. The disclosed apparatus, systems, and methods 400 allow a solar thermal plant to produce electricity at night and on overcast days as well as during fully sunny days. This allows the use of solar power for baseload generation as well as peakpower, with the potential of displacing both coal- and natural gas-fired power plants.

During the day concentrated solar energy 410 is collected at the compact high temperature receiver with fluidized solid particle bed 408 and the collected heat is used to drive turbine 426 and compressor 422 to provide an output through shaft 434 that can be used to drive an electrical generator.

Simultaneously, the collected heat is transferred to the insulated storage silo 440 where it is captured and stored for future use.

During the night there is no solar energy; therefore, the stored heat in the insulated storage silo 440 is used to drive turbine 426 and compressor 422 which provides an output through shaft 434 that can be used to drive an electrical generator.

Referring again to FIG. 4, the operation of Applicant's disclosed apparatus, systems, and methods 400 begins with concentrated solar energy 410 being collected at the compact high temperature receiver with fluidized solid particle bed 408. The compact high temperature receiver with fluidized solid particle bed 408 includes fluidized particle bed 412.

During the day heat energy is collected at the compact high temperature receiver with fluidized solid particle bed 408. During the day the heat energy is used for two operations: (1) directly providing power output 434 using the Brayton cycle system 436 and (2) building up stored energy in the insulated storage silo 440 for use at night and on overcast days. The Brayton cycle system is a thermodynamic cycle that describes the workings of a constant pressure heat engine. Turbine engines and jet engines can use the Brayton Cycle. Although the Brayton cycle is usually run as an open system, it is conventionally assumed for the purposes of thermodynamic analysis that the exhaust gases are reused in the intake, enabling analysis as a closed system. The Brayton cycle sy is named after George Brayton (1830-1892), the American engineer who developed it, although it was originally proposed and patented by Englishman John Barber in 1791. It is also sometimes known as the Joule cycle. Brayton cycle systems are well known in the art and all the details of the system will not be included here. It is to be understood that the Brayton cycle system 436 can be any of the Brayton cycle systems know in the art.

With regard to operation (1), working fluid 402 is directed into the compact high temperature receiver with fluidized solid particle bed 408 using the pump 404. The arrows 414 illustrate the flow of working fluid thru the fluidized solid particle bed 408. The working fluid takes up the heat energy in the fluidized solid particle bed 408. The heat energy is transferred to the counter flow heat exchanger 418 through the line (heated working fluid from particle bed) 416 and the to the Brayton cycle system 436 through line 420. The Brayton cycle system 436 uses the heat energy to drive turbine 426 and compressor 422 and provide an output through shaft 424 and 434 that can be used to drive an electrical generator.

One of the most significant motivations for the use of thermal energy storage in connection with a solar thermal power plant is that, whereas the maximum solar flux typically occurs at near noon, the maximum electric power consumption typically occurs about four hours later. The greatest burden on the electric power grid occurs during these times of greatest electricity consumption. This burden is especially great for the sunniest, hottest days of the summer months. Applicant's apparatus, systems and methods are able to help with this burden by directly producing power with the Brayton cycle system 436 during the times of maximum solar flux and to supplement the production of power using stored energy in the insulated storage silo 440 by that is transferred to the Brayton cycle system 436 through the counter flow heat exchanger 430 during these times of greatest electricity consumption.

With regard to operation (2), working fluid 402 is directed into the compact high temperature receiver with fluidized solid particle bed 408 using the pump 404. The particles in one embodiment are sand particles. In another embodiment the particles are pebbles. In another embodiment the particles are nanoparticles. In another embodiment the particles are spheres. The arrows 414 illustrate the flow of working fluid thru the fluidized solid particle bed 408. The particles are transferred into the insulated storage silo 440 through line 438. The insulated storage silo 440 includes a heat insulator 440a. The heat insulator 440a is a substance, whether solid, liquid, or gas, that retards heat flow from the warmer particles in the storage silo 440 to the less warm environment around the storage silo 440. In one embodiment the heat insulator 440a is a fiberglass heat insulator material. In another embodiment the heat insulator 440a is a mineral wool heat insulator material. In another embodiment the heat insulator 440a is a cellulose heat insulator material. In another embodiment the heat insulator 440a is a polyurethane foam heat insulator material. The heat energy collected at the compact high temperature receiver with fluidized solid particle bed 408 is stored in the insulated storage silo 440.

At night and on overcast days, the heat that is stored in the insulated storage silo 440 is used to provide power through shaft 434 that can be used to drive an electrical generator. The heat that is stored in the insulated storage silo 440 is directed to the Brayton cycle system 436 that provides power at night and on overcast days.

In directing the heat to the Brayton cycle system 436, a working fluid such as air is directed to the insulated storage silo 440 through line 452. The working fluid is moved through the heat exchanges 418 and 450 by the blower 446 and then through line 452 to the insulated storage silo 440. The arrows 454 in the fluidized particle bed 412 in the insulated storage silo 440 illustrate the transfer and collection of heat by the working fluid as it moves through the fluidized particle bed 412 in the insulated storage silo 440. The working fluid with the accumulated heat energy is transferred to the Brayton cycle system 436 through line 456 and the counter flow heat exchanger 430. The system 400 includes capture of excess heat from the Counter Flow Heat Exchanger #2 identified by the reference numeral 430. The line 458 with the excess heat directs the excess heat 460 through units 450 and 446 to the heat exchanger 418.

The system 400 includes capture of excess heat from the turbine 426. The excess heat from the turbine 426 is transferred to the Fluidized Bed 412 through line 462.

The Brayton Cycle 436 utilizes the heat energy to turbine 426 which in turn drives compressor 422 to provide an output through shaft 434 that can be used to drive an electrical generator. The heat energy is directed to the turbine 426 through line 432. The energy is then transferred through the shaft 424 to the compressor 422 which drives shaft 424 and the output shaft 434.

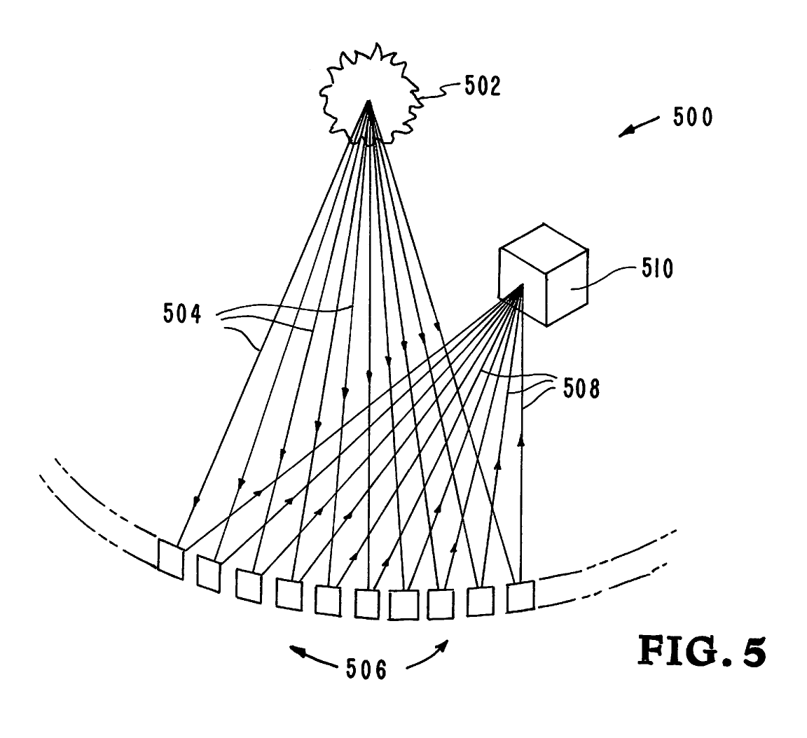

Referring now to FIG. 5, a simplified view of the solar concentrator used in Applicant's disclosed apparatus, systems, and methods is illustrated. The simplified solar concentrator is designated generally by the reference numeral 500. The reference numbers and a brief description of the main components of the system 500 are listed below.
502—Solar source
504—Rays
506—Mirror Array
508—Reflected Rays
510—Compact High Temperature Receiver with Fluidized Solid Particle Bed

The components of Applicant's disclosed apparatus, systems, and methods 500 having been described, the operation of Applicant's disclosed apparatus, systems, and methods will now be considered. The solar source 504, i.e. the sun, produces the solar rays 504. The solar rays are concentrated and directed to the compact high temperature receiver with fluidized solid particle bed 510 by the mirror array 506. The compact high temperature receiver with fluidized solid particle bed 510 includes fluidized particles.

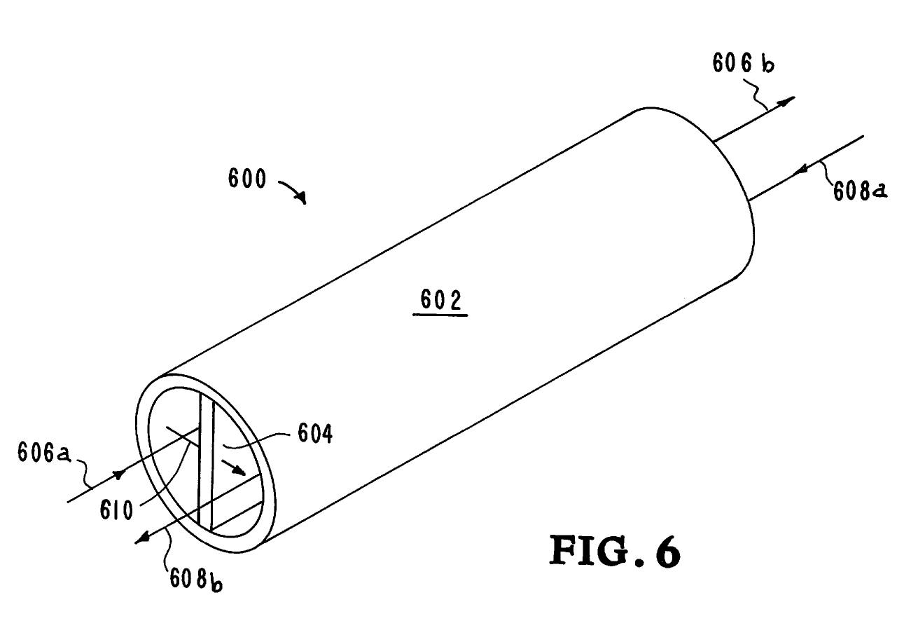

Referring now to FIG. 6, a simplified view of the counter flow heat exchangers used in Applicant's disclosed apparatus, systems, and methods is illustrated. A counter flow heat exchanger is designated generally by the reference numeral 600. The reference numbers and a brief description of the main components of the system 600 are listed below.
602—Pipe
604—Center Divided Wall
606a—Hot Medium (Air) Flow
606b—Cold Medium (Air) Flow
608a—Cooler Flow
608b—Hotter Flow
610—Arrow Indicating Heat Transfer Thru Center Divided Wall 604

The components of Applicant's simplified view of the counter flow heat exchangers 600 used in Applicant's disclosed apparatus, systems, and methods having been described, the operation of Applicant's counter flow heat exchangers 600 will now be considered. Hot medium flow 606a enters the left end of the pipe 602. At the same time, cooler flow 608a of a working fluid enters the right end of the pipe 602. The center divider wall 604 keeps the hot medium flow 606a and the cooler flow 608a of a working fluid separated. Heat is transferred through the center divider wall 604 as indicated by the arrow 610. The heat transfer heats the cooler flow 608a of a working fluid and produces hotter working fluid flow 608b exiting the pipe 602 at the left end. The cold medium flow 606b exits the right end of the pipe 604.

Although the description above contains many details and specifics, these should not be construed as limiting the scope of the application but as merely providing illustrations of some of the presently preferred embodiments of the apparatus, systems, and methods. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

1. An integrated solar power apparatus, comprising:
a solar collector that collects solar energy;
a solar receiver operatively connected to said solar collector;
a fluidized particle bed in said solar receiver, said fluidized bed containing particles wherein said solar energy from said solar collector is transferred to said particles;
a storage container;
a system for conveying said particles with said solar energy from said fluidized particle bed to said storage container wherein said storage container is a repository for said particles with said solar energy;
a power generation system; and
a system for transferring said solar energy from said particles in said storage container to said power generation system.

2. The integrated solar power apparatus of claim 1 wherein said particles are sand particles.

3. The integrated solar power apparatus of claim 1 wherein said particles are pebbles.

4. The integrated solar power apparatus of claim 1 wherein said particles are spheres.

5. The integrated solar power apparatus of claim 1 wherein said particles are sintered bauxite.

6. The integrated solar power apparatus of claim 1 wherein said particles are nanoparticles.

7. The integrated solar power apparatus of claim 1 wherein said storage container is a silo storage container.

8. The integrated solar power apparatus of claim 7 further comprising an insulator around said silo storage container.

9. The integrated solar power apparatus of claim 8 wherein said insulator is a fiberglass insulator.

10. The integrated solar power apparatus of claim 8 wherein said insulator is a fiberglass insulator.

11. The integrated solar power apparatus of claim 8 wherein said insulator is a mineral wool insulator.

12. The integrated solar power apparatus of claim 8 wherein said insulator is a cellulose insulator.

13. The integrated solar power apparatus of claim 8 wherein said insulator is a polyurethane foam insulator.

14. The integrated solar power apparatus of claim 1 wherein said power generation system is a Brayton Cycle system.

15. An integrated solar power apparatus, comprising:
a solar collector that collects solar energy;
a solar receiver operatively connected to said solar collector;
a fluidized particle bed in said solar receiver, said fluidized bed containing particles wherein said solar energy from said solar collector is transferred to said particles;
a storage container;
a system for conveying said particles with said solar energy from said fluidized particle bed to said storage container wherein said storage container is a repository for said particles with said solar energy;
a Brayton Cycle power generation system; and
a system for transferring said solar energy from said particles in said storage container to said Brayton Cycle power generation system.

16. The integrated solar power apparatus of claim 15 wherein said storage container is a silo storage container.

17. The integrated solar power apparatus of claim 16 further comprising an insulator around said silo storage container.

18. The integrated solar power apparatus of claim 15 wherein said particles are sand particles.

19. The integrated solar power apparatus of claim 15 wherein said particles are pebbles.

20. The integrated solar power apparatus of claim 15 wherein said particles are spheres.

21. The integrated solar power apparatus of claim 15 wherein said particles are sintered bauxite.

22. The integrated solar power apparatus of claim 15 wherein said particles are nanoparticles.

23. An integrated solar power method, comprising the steps of:
providing a solar collector that collects solar energy;
providing a solar receiver operatively connected to said solar collector;
providing a fluidized particle bed in said solar receiver, said fluidized bed containing particles wherein said solar energy from said solar collector is transferred to said particles;
providing a storage container;
providing a system for conveying said particles with said solar energy from said fluidized particle bed to said storage container wherein said storage container is a repository for said particles with said solar energy;
providing a power generation system; and
providing a system for transferring said solar energy from said particles in said storage container to said power generation system.

24. The integrated solar power method of claim 23 wherein said step of providing a power generation system comprises providing a Brayton Cycle system.
